(19) United States
(12) Patent Application Publication
(10) Pub. No.: US 2011/0057883 A1
(43) Pub. Date: Mar. 10, 2011

(54) ELECTRONIC SCRATCH SYSTEM AND METHOD OF IMPLEMENTING ELECTRONIC SCRATCH

(76) Inventor: I-Hung Hung, Wugu Hsiang (TW)

(21) Appl. No.: 12/555,503

(22) Filed: Sep. 8, 2009

(51) Int. Cl. G06F 3/041; G08C 21/00

(52) U.S. Cl. 345/173; 178/18.03

(57) ABSTRACT

The invention discloses an electronic scratch system and method. The electronic scratch system includes an electronic device and a storage device for storing a first accessible image. The electronic device includes a receiving unit, a storage unit, a display unit and a processing unit. The receiving unit is used for receiving the first accessible image from the storage device, and the storage unit is used for storing a second accessible image. The processing unit is used for combining the first accessible image with the second accessible image to produce a recognizable image and further displaying the recognizable image on the display unit. The electronic scratch system not only decreases attrition rate of materials but provides an interactive platform.

### BACKGROUND OF THE INVENTION

1. Field of the Invention

The present invention relates to an electronic scratch system and a method of implementing an electronic scratch. More particularly, the invention relates to an electronic scratch system and method of using the visual cryptographic technique, for replacing the traditional paper-based scratch.

2. Description of the Prior Art

With the rise of electronics and the internet society, traditional daily life is being gradually replaced with the life of electronic means, and no one can neglect the importance of the digital age. When electronic technique overthrows the traditional merchandise, more original merchandise becomes digitalized by using the electronic and information technique. The electronic merchandise provides manufacturers with a new market, and also supplies convenient service in modern life.

With the developed information technique, many encryption and decryption techniques can also be applied to merchandise needing to be encrypted and decrypted in daily life, and furthermore this kind of merchandise can become electronic. For example, the RSA encryption algorithm is one kind of special asymmetric cryptography. Two prime numbers are used as two keys for encryption and decryption, respectively, where one is a public key and the other is a private key. The public key is used for encryption, and only the private key can be used for decryption. As long as the person allowed to decrypt does not disclose the private key, it is hard to figure out the private key from the public key, even by reverse engineering. Therefore, the RSA algorithm can be a quite safe encryption and decryption algorithm. Additionally, the visual cryptographic technique is also an encryption technique.

In the prior art, the scratch product is mostly prepared by using a piece of paper and printing a protection membrane to cover up the hidden data. After a user scratches the protection membrane, the content of the hidden data can be known. For example, the scratch-based lottery is prepared by using a piece of paper and printing a protection membrane over the hidden words, and a consumer needs to scratch the protection membrane to see whether he wins the lottery or not. But, the disadvantage of the scratch-based lottery is that the paper is not waterproof and is easy to damage, and the protection membrane is also easy to be worn away after a period of time.

Therefore, to solve the aforementioned problem, the main scope of the invention is to provide an electronic scratch system and a method of implementing an electronic scratch.

### SUMMARY OF THE INVENTION

One scope of the invention is to provide an electronic scratch system and a method of implementing an electronic scratch, where original image data is encrypted by an encryption algorithm. When a user scratches a specific region on a screen of an electronic device, the original image data will be decrypted and displayed on the specific region so that an electronic scratch is achieved to replace the traditional paper-based scratch.

According to an embodiment of the invention, the electronic scratch system includes a storage device and an electronic device. The electronic device includes a receiving unit, a storage unit, a display unit, and a processing unit.

In this invention, an original image is encrypted to generate a first accessible image and a second accessible from the encrypted image by the visual cryptographic technique. The first accessible image is stored in the storage device, and the second accessible image is stored in the storage unit of the electronic device. The receiving unit can receive the first accessible image form the storage device through wired or wireless communications. The processing unit divides the first accessible image and the second accessible image respectively into a plurality of first blocks and a plurality of second blocks, and displays a plurality of regions on a screen of the display unit. Each region corresponds to one of the first blocks and one of the second blocks. When the screen is scratched in each of the regions by a user, the processing unit combines said one first block with said one second block, corresponding to said each region being scratched, to produce a recognizable image, and further displays the recognizable image on the display unit.

Compared to the prior art, this invention uses the electronic scratch system to replace the traditional paper based scratch. The electronic scratch system is easy to carry and reduces paper consumption. The invention uses an encryption algorithm to encrypt the confidential data to prevent the revealing of the data and increase the reliability. Additionally, more convenient transmission of the confidential data and an interactive presentation are provided by the electronic device, and thus an electronic scratch way is achieved.

The advantage and spirit of the invention may be understood by the following recitations together with the appended drawings.

### BRIEF DESCRIPTION OF THE APPENDED DRAWINGS

FIG. 1 is an appearance view illustrating an electronic scratch system according to one embodiment of the invention.

FIG. 2 illustrates a function block diagram of the electronic scratch system in FIG. 1.

FIG. 3 is a schematic diagram of combining a first block of a first accessible image with a second block of a second accessible image to produce a recognizable image.

FIG. 4(A) is a former-part flow chart illustrating a method of implementing an electronic scratch according to one embodiment of the invention.

FIG. 4(B) is a latter-part flow chart illustrating a method of implementing an electronic scratch according to one embodiment of the invention.

### DETAILED DESCRIPTION OF THE INVENTION

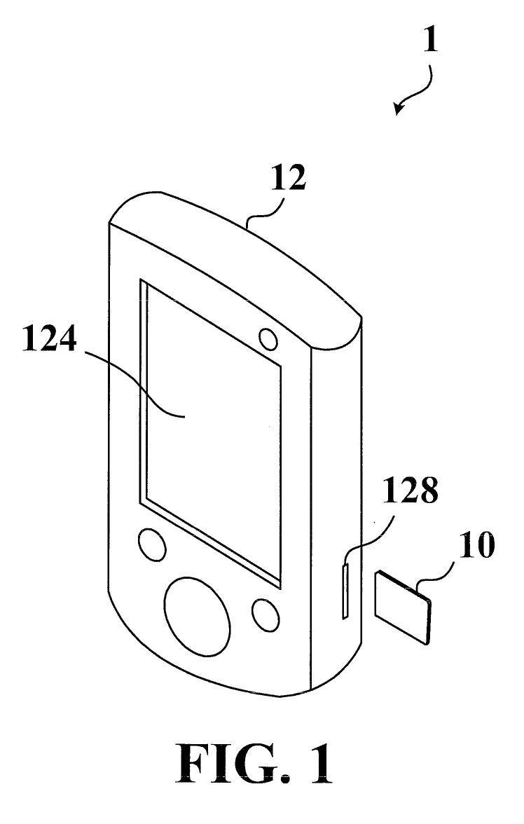

FIG. 1 is an appearance view illustrating an electronic scratch system according to one embodiment of the invention. Referring to FIG. 1, the electronic scratch system 1 includes a storage device 10 and an electronic device 12. The storage device 10 may be, for example, a mini hard disk or a memory card, wherein the memory card may be, for example, a compact flash card, an xD picture card, a Secure Digital card, a multi media card, a smart media card, or a memory stick. The electronic device 12 may be, for example, a mobile phone, a personal digital assistant, or a handheld computer.

As shown in FIG. 1, the electronic device 12 has a display unit 124 and a slot 128. After the storage device 10 is inserted into the slot 128, the electronic device 12 can receive data from the storage device 10. It is noted that the electronic device 12 can receive data from the storage device 10 through wired or wireless communication.

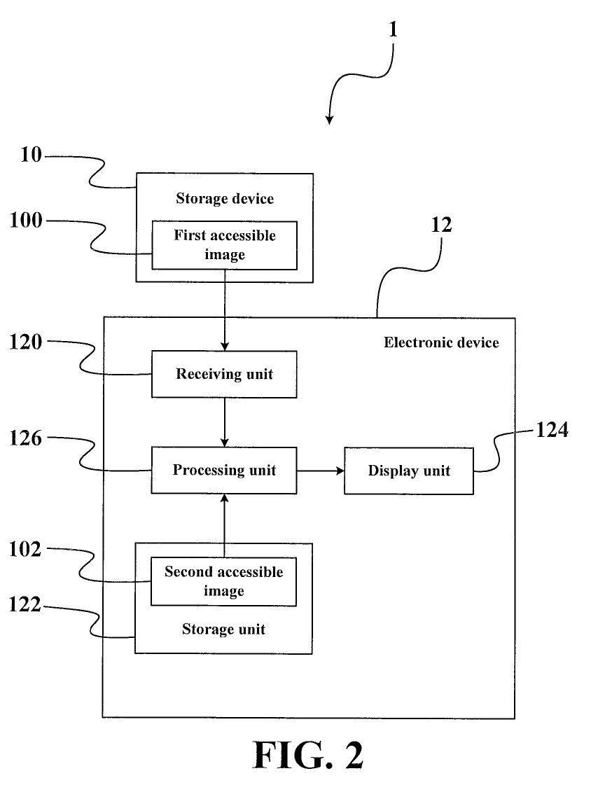

FIG. 2 illustrates a function block diagram of the electronic scratch system 1 in FIG. 1. Referring to FIG. 2, the electronic device 12 includes a receiving unit 120, a storage unit 122, a display unit 124 and a processing unit 126. In practical applications, an original image is encrypted by employing the visual cryptographic technique to generate a first accessible image 100 and a second accessible image 102 in advance. It is noted that the original image may be, but not limited to, a confidential image. The first accessible image 100 is stored in the storage device 10, and the second accessible image 102 is stored in the storage unit 122 of the electronic device 12. The concept of the visual cryptographic technique is presented first by Noar and Shamir, and the major difference between the visual cryptographic technique and the traditional cryptographic technique is in the decryption process. One original image can be encrypted into N sheets of accessible images via employing the visual cryptographic technique. The N sheets of accessible images can be caused to overlap, and the original image can be seen by one using his human eyes. The visual cryptographic technique can be employed easily by a person skilled in the relevant art, and thus it will not be described in more detail herein.

The receiving unit 120 of the electronic device 12 can receive the first accessible image 100 from the storage device 10 by wired or wireless communication between the storage device 10 and the electronic device 12. In this embodiment, the display unit 124 may be, but not limited to, a touch screen. When the display unit 124 is a touch screen, a user can use a touch pen or other similar tools to scratch directly on the screen of the display unit 124.

In addition, to prevent revealing the confidential data in the first accessible image 100 and the second accessible image 102, the first accessible image 100 may be encrypted with a public key of RSA encryption algorithm in advance, and a private key may be stored in the storage unit 122. After the receiving unit 120 receives the first accessible image 100 from the storage device 10, the processing unit 126 can use the private key to decrypt the first accessible image 100. The RSA encryption algorithm can be employed easily by a person skilled in the relevant art, and thus it will not be described in more detail herein.

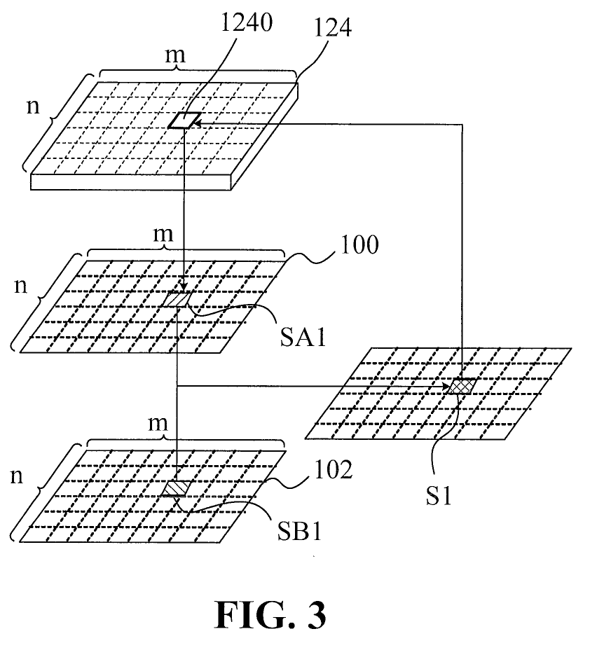

When a user wants to scratch on the screen of the electronic device 12, the user needs to insert the storage device 10 into the slot 128 of the electronic device 12, or the storage device 10 communicates with the electronic device 12 via wired or wireless communication. Next, the receiving unit 120 receives the first accessible image 100 from the storage device 10. If the first accessible image 100 is encrypted with the public key in advance, the processing unit 126 can use the private key of the storage unit 122 to decrypt the first accessible image 100. Afterwards, the processing unit 126 divides the first accessible image 100 and the second accessible image 102 respectively into a plurality of first blocks and a plurality of second blocks, and displays a plurality of regions on the screen of the display unit 124. The number of the first blocks, the number of the second blocks, and the number of the regions may be the same. As shown in FIG. 3, the same number is the product of m and n (hereinafter denoted by m*n), that is, the first accessible image 100 and the second accessible image 102 are divided into the product of m and n blocks, respectively. In addition, the product of m and n regions 1240 are displayed on the display unit 124. Each region 1240 corresponds to one of the m*n first blocks SA1 and one of the m*n second blocks SB1, where m and n are positive integers.

When the screen of the display unit 124 of the electronic device 12 is scratched in each of the m*n regions by a user, the processing unit 126, according to a series of digits, puts a first block of the first accessible image 100 and a second block of the second accessible image 102, corresponding to said each region being scratched, into the storage unit 122. After checking the series of digits, if the series of digits of the first block matches that of the second block, the processing unit 126 will combine the first block and the second block to produce a recognizable image. Finally, the recognizable image can be displayed on the displaying unit 124 by the processing unit, and then the original image data in the scratched region can be seen by the user.

A practical embodiment is as follows and is described to further understanding of this invention.

It is supposed that the series of digits consists of 24 digits, which are M, P1, N, P2, R, P3, L, P4, U, No. 5, D, No. 6, M1, No. 7, Mr, No. 8, Nu, No. 9, Nd, No. 10, No. 4, No. 3, No. 2, and No. 1 in sequence. M is a column number for a column of the first accessible image. N is a row number for a row of the first accessible image. R is the number of times a 90-degree right turn of the whole first accessible image is performed. L is the number of times a 90-degree left turn of the whole first accessible image is performed. U is the number of times a 180-degree up-to-down turn of the whole first accessible image is performed. D is the number of times a 180-degree down-to-up turn of the whole first accessible image is performed. M1 is the number of columns by which the whole first accessible image is left-shifted. Mr is the number of columns by which the whole first accessible image is right-shifted. Nu is the number of rows by which the whole first accessible image is up-shifted. Nd is the number of rows by which the whole first accessible image is down-shifted. Nos. 1˜10 represent a serial number with 10 digits. P1˜4 represent 4 digits that are an image number of the first accessible image It is noted that the series of digits may include at least one digit forming one of the above different numbers. The above digits are further explained below.

As shown in FIG. 3, the first accessible image 100 and the second accessible image 102 are divided into m*n blocks, respectively. Further, M and N mean the column number of a column and the row number of a row, of each accessible image, respectively.

In practical applications, a group of first accessible images may be generated and stored in various storage devices. Each of these first accessible images is assigned a series of digits. If the series of digits of a certain first accessible image matches that of the second accessible image, the original image will be produced after checking the series of digits. It's also noted that these first accessible images can have their respective image numbers. Moreover, in a preferred embodiment, in order to assign these series of digits regularly, the above-mentioned digits, e.g. R, U, and Mr, can be applied in ways as follows.

For example, it is assumed that the series of digits of one first accessible image is determined. If said one first accessible image is programmed to undergo a 90-degree right turn, then the value R can be varied to modify the series of digits of said one first accessible image. Thus, this modified series of digits can be assigned to next one first accessible image. Similar actions can be implemented by use of the digits of L, U, and D, and such actions are not repeated herein.

As another example, it is assumed that the series of digits of one first accessible image is determined. If said one first accessible image is programmed to shift to the left by a number of columns, then the value M1 can be varied to modify the series of digits of said one first accessible image. Thus, this modified series of digits can be assigned to the next one first accessible image. Similar actions can be implemented by use of the digits of Mr, Nu and Nd, and such actions are not repeated herein. Practically, depending on the number of these first accessible images, at least one of such digits R, L, U, D, M1, Mr, Nu, and Nd may be applied to modify the series of digits.

Given that the receiving unit 120 receives the first accessible image 100 from the storage device 10, it is supposed that the series of digits of the first accessible image 100 is 888000000000000000000001, wherein the image number of the first accessible image is 0008, the serial number is 0000000001, and the sequential digits of MNRLUDM1MrNuNd are 8800000000.

Next, the processing unit 126 uses the private key of the storage unit 122 to decrypt the first accessible image 100. Then, the processing unit 126 obtains a corresponding image from the storage unit 122, according to the image number of the first accessible image 100, as the second accessible image 102. In this embodiment, the processing unit 126 obtains the image whose image number is 0008 as the second accessible image 102 from the storage unit 122, and divides the first accessible image 100 and the second accessible image 102 respectively into a plurality of first blocks and a plurality of second blocks. As shown in FIG. 3, the first accessible image 100 and the second accessible image 102 are respectively divided into 54 first blocks and 54 second blocks, i.e. 54(=9*6) is equal to the product of m and n in this embodiment.

As shown in FIG. 3, when the first block SA1 is scratched by a user via the display unit 124, the processing unit 126 can, according to the sequential digits of MNRLUDM1MrNuNd, put the first block SA1 into a corresponding place in the storage unit 122 and cause the first block SA1 and a second block SB1 to overlap for producing a recognizable image S1 after checking the series of digits. The recognizable image S1 is then displayed on the display unit 124. Therefore, the data (may be confidential) of the original image in the scratched region can be seen by the user.

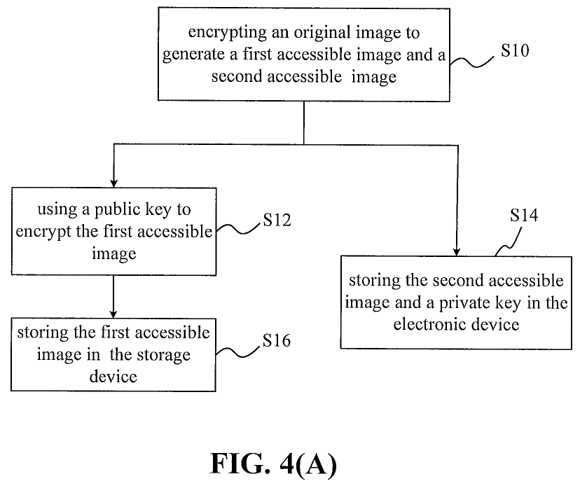

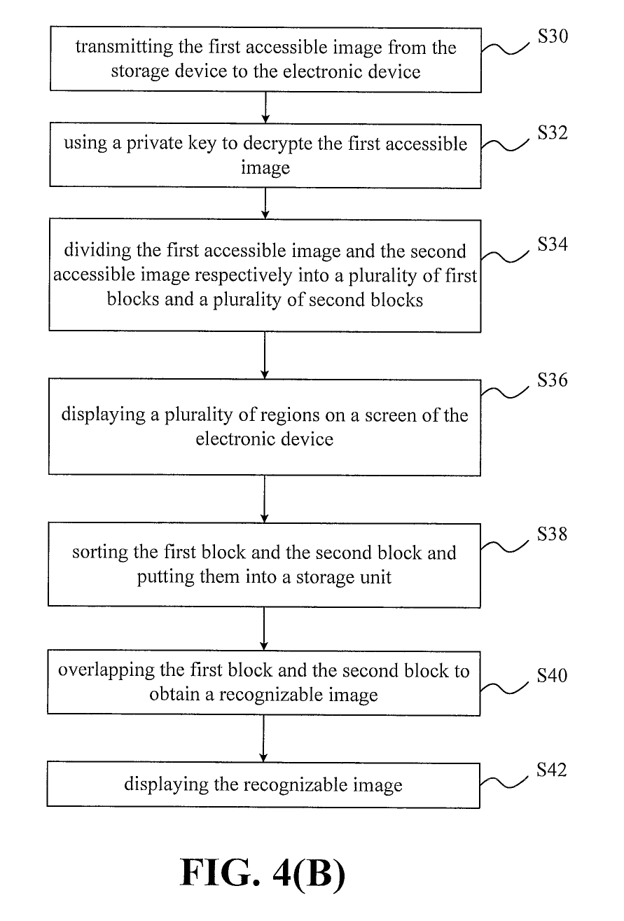

Referring to FIG. 4(A), it is a former-part flow chart illustrating a method of implementing an electronic scratch according to one embodiment of the invention. Referring to FIG. 1 and FIG. 2, in executing step S10 first, an original image is encrypted to generate a first accessible image 100 and a second accessible image 102. Then, in executing step S12, the first accessible image 100 is encrypted by a public key. In executing step S14, the second accessible image 102 and a private key are stored in the electronic device 12. Afterwards, in executing step S16, the first accessible image 100 is stored in the storage device 10.

Referring to FIG. 4(B), it is a latter-part flow chart illustrating a method of implementing an electronic scratch according to one embodiment of the invention. Referring to FIG. 1 and FIG. 2, when a user wants to scratch, the user needs to insert the storage device 10 into the slot 128 of the electronic device 12, or the storage device 10 communicates with the electronic device 12 via wired or wireless communication. While the storage device 10 is communicating with the electronic device 12, in executing step S30, the first accessible image 100 is transmitted from the storage device 10 to the electronic device 12, i.e. the electronic device 12 receives the first accessible image 100 through the receiving unit 120. Next, in executing step S32, the first accessible image 100 is decrypted by the private key. In executing step S34, the first accessible image 100 and the second accessible image 102 are respectively divided into a plurality of first blocks SA1 and a plurality of second blocks SB1. Afterwards, in executing step S36, a plurality of regions 1240 are displayed on the screen of the display unit 124, wherein each region corresponds to one of the plural first blocks and one of the plural second blocks.

When each region is scratched, in executing step S38, the electronic device 12 puts, according to a series of digits, the first block of the first accessible image 100 and the second block of the second accessible image 102, corresponding to said each region being scratched, into the storage unit 122 of the electronic device 12 and then checks the series of digits. Next, in executing step S40, the first block of the first accessible image 100 and the second block of the second accessible image 102 overlap to produce a recognizable image. Finally, in executing step S42, the recognizable image is displayed on the display unit 124 of the electronic device 12. It is noted that the working principle of this embodiment is the same as that of the aforementioned embodiment, and thus it will not be repeated herein.

The electronic scratch system of this invention can be applied to a scratch-based lottery, i.e. the scratch-based lottery is encrypted to make an electronic scratch-based lottery. Many electronic scratch-based lotteries can be stored in various storage devices to achieve the effect of easy candying and rapid prize-checking for plural scratches. Additionally, the electronic scratch system of this invention can also be applied to puzzle games, e.g. bingo, or an interactive learning system, e.g. the language learning or the preschool-children learning.

Compared to the prior art, this invention uses the electronic scratch system to replace the traditional paper-based scratch. The electronic scratch system is easy to carry and reduces paper consumption. The invention uses an encryption algorithm to encrypt the confidential data to prevent the revealing of the data and thus increases the reliability. Additionally, more efficacious transmission of the confidential data and an interactive presentation are provided by the electronic device, and thus an electronic scratch way is achieved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electronic scratch system, comprising:
a storage device for storing a first accessible image;
an electronic device, comprising:
a receiving unit for receiving the first accessible image from the storage device;
a storage unit for storing a second accessible image;
a display unit; and
a processing unit for dividing the first accessible image and the second accessible image respectively into a plurality of first blocks and a plurality of second blocks, and displaying a plurality of regions on a screen of the display unit, wherein each of the regions corresponds to one of the first blocks and one of the second blocks;
wherein when the screen is scratched in each of the regions, the processing unit combines said one first block with said one second block to produce a recognizable image and further displays the recognizable image on the display unit.

2. The electronic scratch system of claim 1, wherein the number of the first blocks is the same as the number of the second blocks.

3. The electronic scratch system of claim 2, wherein the number of the first blocks, the number of the second blocks and the number of the regions are the same.

4. The electronic scratch system of claim 1, wherein the number of the first blocks is equal to the product of in and n, the number of the second blocks is equal to the product of m and n, and the number of the regions is equal to the product of m and n, where m and n are positive integers.

5. The electronic scratch system of claim 1, wherein the first accessible image is encrypted with a public key in advance, the storage unit stores a private key, and the processing unit uses the private key to decrypt the first accessible image.

6. The electronic scratch system of claim 1, wherein the first accessible image and the second accessible image are produced by a visual cryptographic technique.

7. The electronic scratch system of claim 1, wherein when the screen is scratched in each of the regions, the processing unit, according to a series of digits, puts said one first block and said one second block corresponding to said each of the regions into the storage unit, and combines said one first block and said one second block to produce the recognizable image after checking the series of digits.

8. The electronic scratch system of claim 7, wherein the series of digits comprises at least one digit selected from the group consisting of the row number of a row of the first accessible image, the column number of a column of the first accessible image, the number of times a 90-degree right turn of the whole first accessible image is performed, the number of times a 90-degree left turn of the whole first accessible image is performed, the number of times a 180-degree up-to-down turn of the whole first accessible image is performed, the number of times a 180-degree down-to-up turn of the whole first accessible image is performed, the number of columns by which the whole first accessible image is left-shifted, the number of columns by which the whole first accessible image is right-shifted, the number of rows by which the whole first accessible image is up-shifted, the number of rows by which the whole first accessible image down-shifted, a serial number, and an image number of the first accessible image.

9. The electronic scratch system of claim 1, wherein the display unit comprises a touch screen display.

10. A method of implementing an electronic scratch, comprising the steps of:
encrypting an image and generating a first accessible image and a second accessible image from the encrypted image;
storing the first accessible image in a storage device;
storing the second accessible image in an electronic device;
transmitting the first accessible image from the storage device to the electronic device by communication between the storage device and the electronic device;
dividing the first accessible image and the second accessible image respectively into a plurality of first blocks and a plurality of second blocks at the electronic device;
displaying a plurality of regions on a screen of the electronic device, wherein each of the regions corresponds to one of the first blocks and one of the second blocks;
when the screen is scratched in each of the regions, combining said one first block with said one second block, corresponding to said each of the regions, to produce a recognizable image; and
displaying the recognizable image on the electronic device.

11. The method of claim 10, wherein the number of the first blocks is the same as the number of the second blocks.

12. The method of claim 11, wherein the number of the first blocks, the number of the second blocks and the number of the regions are the same.

13. The method of claim 10, wherein the number of the first blocks is equal to the product of m and n, the number of the second blocks is equal to the product of m and n, and the number of the regions is equal to the product of m and n, where m and n are positive integers.

14. The method of claim 10, further comprising the steps of:
using a public key to encrypt the first accessible image; and
storing a private key in the electronic device.

15. The method of claim 14, further comprising the step of:
after the first accessible image is transmitted from the storage device to the electronic device, using the private key to decrypt the first accessible image.

16. The method of claim 10, wherein the image is encrypted by a visual cryptographic technique.

17. The method of claim 10, further comprising the step of:
when the screen is scratched in each of the regions, putting, according to a series of digits, said one first block and said one second block, corresponding to said each of the regions, into a storage unit of the electronic device, and combining said one first block and said one second block to produce the recognizable image after checking the series of digits.

18. The method of claim 17, wherein the series of digits comprises at least one digit selected from the group consisting of the row number of a row of the first accessible image, the column number of a column of the first accessible image, the number of times a 90-degree right turn of the whole first accessible image is performed, the number of times a 90-degree left turn of the whole first accessible image is performed, the number of times a 180-degree up-to-down turn of the whole first accessible image is performed, the number of times a 180-degree down-to-up turn of the whole first accessible image is performed, the number of columns by which the whole first accessible image is left-shifted, the number of columns by which the whole first accessible image is right-shifted, the number of rows by which the whole first accessible image is up-shifted, the number of rows by which the whole first accessible image down-shifted, a serial number, and an image number of the first accessible image.
